(19) United States
(12) Patent Application Publication
(10) Pub. No.: US 2021/0094864 A1
(43) Pub. Date: Apr. 1, 2021

(54) MACHINE AND METHOD FOR MANUFACTURING GLASS OBJECTS

(71) Applicant: ARC FRANCE, Arques (FR)

(72) Inventors: José DUPLOUICH, Arques (FR); Joël HENNEBIL, Arques (FR); Martial HAMEAU, Arques (FR); Eric CARNEL, Arques (FR); Sébastien DONZE, Arques (FR)

(73) Assignee: ARC FRANCE, Arques (FR)

(21) Appl. No.: 16/954,808

(22) PCT Filed: Dec. 19, 2018
(86) PCT No.: PCT/FR2018/053411

§ 371 Date: Jun. 17, 2020

(30) Foreign Application Priority Data
Dec. 22, 2017 (FR) 1763094

(51) Int. Cl. C03B 9/197; C03B 9/33

(52) U.S. Cl. CPC C03B 9/197; C03B 9/33

(57) ABSTRACT

Machine and method for manufacturing glass objects, in particular stemmed glass, comprising a blank mold 1 configured to receive glass at flow temperature, and a pressing punch 2 that can be moved in translation along a first axis, characterized in that the blank mold 1 comprises an upwardly flared upper portion 3 formed of one part, and an upwardly non-flared lower portion 13 formed of multiple parts, the parts of the lower portion 13 being movable in translation with a component along axes arranged in a plane normal to the first axis, the upper portion 3 having, along any axis normal to the first axis, a minimum dimension greater than the maximum dimension of the lower portion 13 along the axis normal to the first axis so that the molded object in the lower portion 13 can pass through the upper portion 3 in translation along the first axis.

### FIELD OF THE INVENTION

The present invention relates to a machine for manufacturing glass objects.

### BACKGROUND

The machine receives glass brought to a sufficient temperature to enable the flow thereof by gravity. The malleable glass is shaped and cooled.

U.S. Pat. No. 2,115,765 describes a tool for forming a gripping handle on a molded glass lid. To this end, the mold is produced in an outer ring and an inner portion with two articulated jaws. Once the glass has been poured and molded, the inner portion is raised and the jaws are opened releasing the handle. Such a tool is unsuitable for mass production. The articulation of the jaws is located in an area of high temperature requiring either special alloys, or very frequent replacement of parts. The actual mechanism is axially cumbersome is unsuitable for drinking glasses.

CA 450 853 proposes gripping, after the molding, an area to be deformed. However, at that moment, the glass is sufficiently cooled to be little deformable and to require a mechanical force such that the risk of breaking the glass object is high.

The applicant has sought to remedy said drawbacks. The applicant has sought to make the manufacturing of the stem and the manufacturing of the parison of a drinking glass as independent as possible. This enables a reduced handling and a more effective use of machines, for example a maintenance stoppage on a glass stem pressing machine becomes without impact on the production of parisons. Yet, the sealing of glass requires similar material thicknesses to benefit from homogeneous cooling, high thicknesses in the order of 5 to 6 mm and requires an energy input. The other modes of fastening the stem and parison have not known success to date, whether for aesthetical, daily use or even robustness reasons.

### SUMMARY

More specifically, the invention offers a freedom of shape under the parison. The invention also offers the freedom of choice of the glass thickness.

The invention proposes a machine for manufacturing glass objects, particularly stemmed glass, comprising a blank mold configured to receive glass at flow temperature, and a pressing punch moveable in translation along a first axis, characterized in that the blank mold comprises an upwardly flared upper portion formed of one-piece, and an upwardly non-flared lower portion and produced in a plurality of parts, the parts of the lower portion being moveable in translation with a component along axes arranged in a plane normal to the first axis, the upper portion having a minimum dimension along any axis normal to the first axis, greater than the maximum dimension of the lower portion along said axis normal to the first axis so that the molded object in the lower portion can pass into the upper portion in translation along the first axis. Thus, it can be manufactured a blank of non-monotonic diameter in the blank mold.

In one embodiment, the upper portion constitutes a parison mold and the lower portion constitutes a member mold arranged below the parison. The parison may be provided with a protruding functional member.

In one embodiment, the parts of the lower portion are at least two in number. In practice, it can be provided two to ten identical parts forming together a circle.

In one embodiment, the parts of the lower portion are mold sectors.

In one embodiment, the parts of the lower portion define a lateral protrusion. The lateral protrusion is preferably annular. The blank may be rotatable for a finishing step.

In one embodiment, the parts of the lower portion are moveable in translation in the plane normal to the first axis.

In one embodiment, the mold has a molding position wherein the parts of the lower portion are clamped against one another defining a molding surface open towards the upper portion and closed laterally and downwardly, and an opening position wherein the parts of the lower portion are moved apart from one another. The blank may then be demolded.

In one embodiment, the machine comprises an actuator arranged below the lower portion and acting on the parts of the lower portion between a clamped position and a position moved apart from one another. The actuator may be protected from the heat of the blank.

In one embodiment, between the actuator and the parts of the lower portion are provided inclined ramps transforming the translation along the first axis into translation along the second axis. The machine is compact along the second axis enabling an assembly on a carousel.

In one embodiment, the machine comprises a blow mold assembled downstream of the blank mold. The blow mold is configured to be without contact deforming with the lower portion of the blank corresponding to the lower portion of the blank mold. The lower portion of the blank is protected. The lower portion of the blank is formed in a single step. If applicable, blowing may be produced in the blow mold.

In one embodiment, the lower portion of the blank mold is frustoconical with an annular groove.

The invention also proposes a method for manufacturing glass objects, particularly stemmed glass, comprising:

Providing a blank mold with closed bottom, comprising an upwardly flared upper portion formed of one-piece, and an upwardly non-flared lower portion and produced in a plurality of parts,

pouring glass at flow temperature into the blank mold,

moving a pressing punch moveable in translation along a first axis by pressing the glass against the blank mold, then removing same,

moving apart parts of a lower portion moveable in translation with a component along a second axis perpendicular to the first axis,

demolding the blank from the upper portion of the mold by a movement along the first axis.

The lower portion of the blank mold has a freedom of shape and the blank may be set in the definitive shape thereof by the lower portion of the blank mold.

### BRIEF DESCRIPTION OF THE DRAWINGS

The present invention will be better understood upon studying the detailed description of one embodiment taken by way of non-limiting example illustrated in the appended drawings:

FIG. 1 is an axial sectional view of a machine according to one aspect of the invention in closed position;

FIG. 2 is a view of the machine of FIG. 1 during loading;

FIG. 3 is a view of the machine of FIG. 1 during pressing;

FIG. 4 is a view of the machine of FIG. 1 in end of pressing position;

FIG. 5 is a view of the machine of FIG. 1 during opening;

FIG. 6 is a view of the machine of FIG. 1 during blank mold lowering;

FIG. 7 is a view of the machine of FIG. 1 in blowing position;

FIG. 8 is a view of the machine of FIG. 1 after the blowing;

FIGS. 9 and 10 are enlarged views of FIGS. 4 and 5.

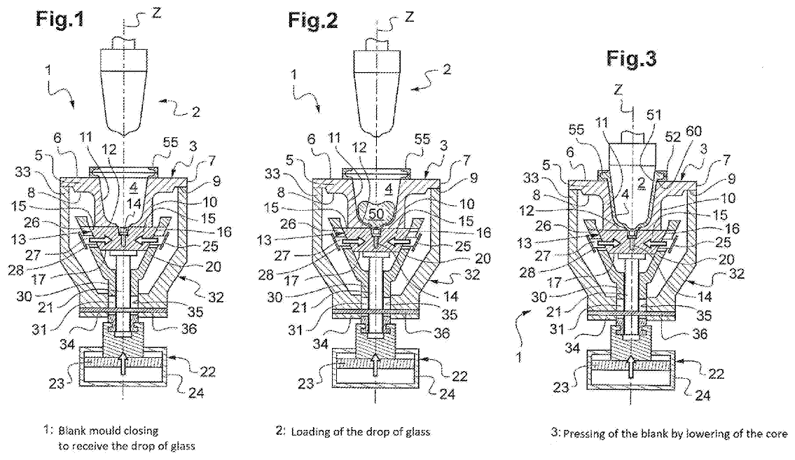

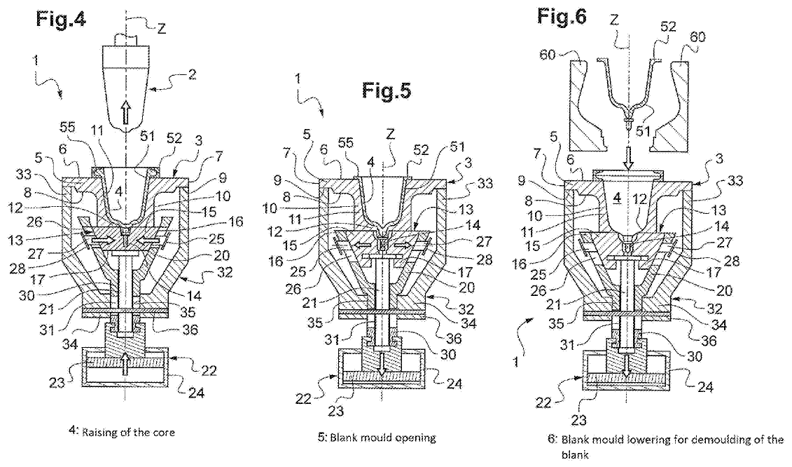

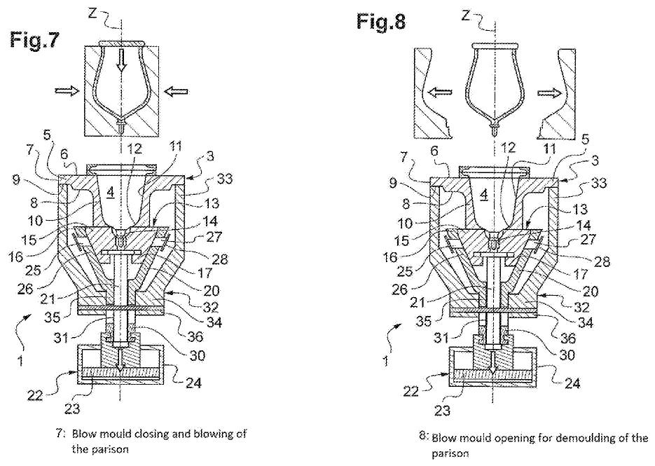

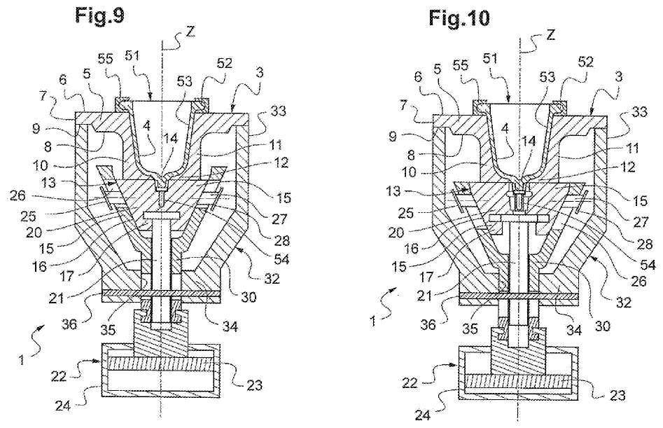

### DETAILED DESCRIPTION OF THE PREFERRED EMBODIMENTS

The drawings and the following description mainly contain elements of certain character. Therefore, not only may they be used to better understand the present invention, but also to contribute to the definition thereof, if applicable.

A first type of machine comprises a blank mold and a blow mold for manufacturing in the so-called press and blow technology. From a drop of glass poured into the blank mold, the glass is pressed in said blank mold.

The blank mold has a molding wall formed of one-piece. A pressing punch is provided at the open end of the blank mold. Once the drop of glass has been poured into the blank mold, the pressing punch is lowered by translation and presses the glass against the outer wall. The blank mold makes it possible to form a blank whereof the bowl or parison portion has an upwardly increasing diameter. In other terms, the demolding requires the diameter of the parison to be monotonically increasing upwardly.

A blank is demolded from the blank mold. Then, the blank is elongated with rotation in the blow mold where the blowing takes place to push the wall of the blank against the molding wall of the blow mold.

The parison is subsequently heat-set by a seal on a glass stem manufactured at the same time.

Moreover, the Applicant also knows the pressing only technique that requires a parison diameter monotonically increasing upwardly and a high glass thickness. The high glass thickness is made necessary by the low fluidity of the glass within the single mold and the difficulty of hot-pressing at temperatures at which most construction steels lose a substantial part of the mechanical properties thereof. Yet, the high glass thickness makes the final product heavy and increases the cost price thereof at each step of the production. The high glass thickness also reduces the freedom of the designer of the shape of the object.

The invention aims to remedy the drawbacks of the first type of machine whilst retaining the advantages thereof, in particular in relation to pressing machines alone. The invention aims to offer a freedom of creation to designers and draftsmen of glasses, in particular drinking glasses, particularly stemmed glasses, beaker glasses, etc. The parison is of free shape and independent of the rest of the glass. The parison is press and blow manufactured with multipart blank molds.

The machine for manufacturing glass objects, particularly drinking glass, comprises a blank mold 1 configured to receive glass at flow temperature, and a pressing punch 2 moveable in translation along a first axis, in general vertical, in an alternative manner. The first axis is here named Z-axis. The punch 2 has a shape of revolution of diameter monotonically increasing from the bottom. The punch 2 is produced in one-piece in refractory alloy. The punch 2 is driven by a linear, in particular, pneumatic or electric, actuator. The punch 2 is provided to form the inner surface of a glass blank 51.

The blank mold 1 comprises an upper portion 3 formed of one-piece having a molding upper concavity 4 or upwardly flared inner surface. The molding upper concavity 4 has a shape of revolution of diameter monotonically increasing from the bottom. The molding upper concavity 4 has a small diameter opening at the lower end thereof and a large diameter opening at the upper end thereof. The molding upper concavity 4 is coaxial with the punch 2. The upper portion 3 is produced in one-piece in refractory alloy.

On the upper portion 3, is assembled a blank gripper 55.

In axial section, the upper portion 3 comprises an upper rim 5 extending from the upper end of the molding upper concavity 4. The upper rim 5 has a flat upper surface 6 normal to the Z-axis. The upper rim 5 is annular. The upper rim 5 has a peripheral surface 7 parallel to the Z-axis and a lower surface 8 parallel to upper surface 6. Between the peripheral surface 7 and the lower surface 8 is arranged an annular shoulder 9. The shoulder 9 makes possible a stable assembly and a centering on a support pot see hereafter. The upper portion 3 comprises a molding body 10 extending downwardly from the upper rim 5.

The molding body 10 is generally cup-shaped open at the bottom. The molding body 10 is annular. The molding body 10 comprises an elongated wall 11 along the Z-axis and a disc-shaped bottom 12 in a plane normal to the Z-axis. The elongated wall 11 has a peripheral surface, here in cylinder of revolution, and a frustoconical molding inner surface forming part of the molding upper concavity 4. The bottom 12 has a flat lower surface. The flat lower surface is normal to the Z-axis. The bottom 12 has an upper surface forming molding surface forming part of the molding upper concavity 4. The upper surface is in continuity with the molding inner surface of the elongated wall 11.

The blank mold 1 comprises a lower portion 13 produced in a plurality of molding parts. Molding part means a structural element in contact with the molten glass during molding. The lower portion 13 has an upper surface in contact with the lower surface of the upper portion 3. The lower portion 13 is produced in angular sectors 15 of between two and ten in number. A number chosen between four and ten is preferable to limit the radial movement, the number may take into account the diameter of the part and the variation in diameter between a local minimum and a local maximum located downwardly.

The angular sectors 15 are moveable between a molding position and a demolding position. In molding position, the angular sectors 15 form an upwardly non-flared molding lower concavity 14. The molding lower concavity 14 is downwardly closed. The molding lower concavity 14 is upwardly open in communication with the molding upper concavity.

The angular sectors 15 have separate planes passing through the Z-axis. The angular sectors 15 are moveable in translation with a component along a second axis perpendicular to the Z-axis. Here, the angular sectors 15 are moveable in translation in a plane normal to the Z-axis. The molding lower concavity 14 is of circular or non-circular shape. The molding lower concavity 14 is of diameter not monotonically decreasing downwardly whereas the molding upper concavity 4 is of diameter monotonically decreasing downwardly. Here, the molding lower concavity 14 has an annular groove to form an annular bead in a lower portion of the blank.

In other terms, the molding lower concavity 14 is free of having variations in radial dimension, increasing and decreasing downwardly. The molding lower concavity 14 may require the radial movement of the angular sectors 15 for the demolding whereas the molding upper concavity 4 can be demolded by a relative axial movement of the blank and of said molding upper concavity 4. The upper portion 3 has, along any axis in a plane normal to the first axis, a minimum dimension greater than the maximum dimension of the lower portion along said axis normal to the first axis so that the molded object in the lower portion can pass into the upper portion in translation along the first axis.

Not only are the blank and said molding upper concavity 4 suitable for demolding, but, in addition, the lower portion of the blank molded in the molding lower concavity 14 is suitable for passing into the molding upper concavity 4. In demolding position, the angular sectors 15 are angularly spaced apart from one another and free up a space of radial dimension greater than or equal to the minimum radial dimension of the molding upper concavity 4.

The lower portion 13, in molding position, has a frustoconical peripheral surface 16. The frustoconical peripheral surface 16 is in contact with a frustoconical guide 20. The lower portion 13 has a lower area 17 cooperating with a support arm 21. The cooperation may be provided by axial connection and radial freedom, for example by a T-shaped arm end 21 arranged in a corresponding concave shape.

The frustoconical guide 20 and the support arm 21 are integral with one another. The frustoconical guide 20 and the support arm 21 are moveable in translation along the Z-axis. The frustoconical guide 20 and the support arm 21 are driven by an actuator 22. The actuator 22 comprises, here, a pneumatic assembly—piston 23 and cylinder 24—. The actuator 22 is capable of moving the frustoconical guide 20 and the support arm 21 between a high position and a low position and of holding same in each of said positions. The high position corresponds to the molding position. The low position corresponds to the demolding position.

The transformation of the Z-axis translation of the actuator 22 into radial translation of the angular sectors 15 is performed by the slope of the cone of the frustoconical guide 20 in the direction of the assembly. The lower portion 13 is held immobile along the Z-axis. The upward movement of the frustoconical guide 20, by contact of the frustoconical lower surface with the frustoconical peripheral surface 16 forces the angular sectors 15 to be tightened.

The angular sectors 15 are indexed with the frustoconical guide 20 in the other direction, in particular by means of a T-shaped rail 25 passing into a slot 26 arranged in the frustoconical guide 20. The T-shaped rail 25 comes into contact with the frustoconical outer surface of the frustoconical guide 20. The T-shaped rails 25 and the outer surfaces of the angular sectors 15 form inclined ramps transforming the translation along the first axis into translation in the plane normal to the first axis in cooperation with the inner and outer frustoconical surfaces of the frustoconical guide 20.

More specifically, the T-shaped rail 25 comprises a core 27 and a bar 28. The core 27 is fastened at one end to the angular sector 15 and supports at the opposite end thereof the bar 28, the core 27 passing into said slot 26. The core 27 has a parallelogram shape. The bar 28 is projecting beyond the frustoconical guide 20. Thus, in the opposite direction, the downward movement of the frustoconical guide 20 forces the angular sectors 15 to be moved apart. The bar 28 then exerts a traction on the corresponding angular sector 20.

The frustoconical guide 20 is extended downwardly by a sleeve 30 surrounding the arm 21. The sleeve 30 is pierced by an oblong hole 31. The upper portion 3 of the blank mold 1 rests by the rim 5 on an outer support 32. The outer support 32 is here annular with an upper cylindrical wall 33 supporting said upper portion 3, and a bottom 34 provided with a central through hole 35. The sleeve 30 and the arm 21 pass into said hole 35. A crossbar 36 is fastened to the outer support 32. The crossbar 36 passes through the hole 35. The crossbar 36 passes into the oblong hole 31 of the sleeve 30 and of the arm 21. The oblong hole 31 is of axis normal to the Z-axis and has a main dimension or large diameter along the Z-axis. The sleeve 30 and the arm 21 are rotatably secured to the outer support 32 whilst having a translational freedom along the Z-axis in the limit imposed by the main dimension of the oblong hole 31.

Moreover, the machine also comprises a pressing core or punch 2 moveable in translation along the Z-axis. The punch 2 serves as piston whereas the blank mold 1 serves as cylinder for the formation of the blank from a drop of glass 50 received in the blank mold 1. The punch 2 has a shape and a dimension such that the blank has a relatively homogeneous thickness in the blank portion corresponding to the upper portion 3 of the blank mold 1. The punch 2 remains substantially above the angular sectors 15, in particular at the upper level at the lower surface of the upper portion 3.

In a first step, the actuator 22 pushes the frustoconical guide 20 and the arm 21 upwardly. The angular sectors 15 of the lower portion 13 close and the lower portion 13 and the upper portion 3 form a blank mold closed at the bottom.

In a second step, a drop of glass 50 is loaded in the blank mold 1. The drop of glass 50 has a temperature and therefore a viscosity making same suitable for being shaped. By gravity, the drop of glass is located in the bottom of the concavity of the blank mold 1.

In a third step, the punch 2 lowers and comes into contact with the drop of glass 50. The punch 2 causes the creep of the glass between the walls of the blank mold 1 and of the actual punch 2. The punch 2 also causes the creep of the glass downwardly into the lower portion 13, between the angular sectors 15, and upwardly to form a rim 52 in the gripper 55. The blank 51 comprises a rim 52, an upper portion or parison 53, and a lower portion or functional member 54. The parison 53 is shaped by the punch 2 and the upper concavity 4. The parison 53 is of flared shape so that it can be demolded from the upper portion 3 formed of one-piece. The functional member 54 is non-flared. The functional member 54 is, here, a Z-axis stud turned downwards and having an annular bead in radial projection.

In a fourth step, the punch 2 is raised is thus released from the blank 51. The temperature of the glass of the blank having lowered, the blank 51 retains the shape thereof and the dimension thereof.

In a fifth step, the actuator 22 pulls the frustoconical guide 20 and the arm 21 downwardly. The angular sectors 15 of the lower portion 13 move apart and the lower portion 13 of the blank mold 1 reaches an opening position. The portion of the blank 51 located below the upper portion 3 of the blank mold 1 is released.

In a sixth step, the entire blank mold 1 is released downwardly. The blank 51 is held by the gripper 55 connected with the rim 52. The blank 51 is demolded from the upper portion 13. The blank 51 may be retained by an upper edge. A blow mold 60 produced in a plurality of angular sectors may be brought by a movement in a plane normal to the Z-axis. The blow mold 60 comes into contact with the upper portion of the blank. The blow mold 60 is preferably set apart from the lower portion of the blank. The blow mold 60 is without contact deforming with the lower portion of the blank formed previously by the lower portion of the blank mold.

In a seventh step, the blow mold 60 is closed around the blank 51 and a blowing with pressurized air is produced in the concavity of the blank 51. The parison from the blank 51 may thus take a shape of balloon glass or more generally of glass whereof the mouth has a diameter less than another portion of the parison. The lower portion of the blank 51 corresponding to the lower portion 13 of the blank mold 1 has a free shape in the envelope constituted by the minimum transverse dimensions of the upper portion 3. The lower portion 13 of the blank mold 1 forms a mold for a member arranged below the parison. The lower portion 13 of the blank mold 1 defines a lateral, preferably annular, protrusion of the lower portion of the blank 51.

In an eighth step, the blow mold 60 is moved away and the parison from the blank 51 is demolded.

The invention provides a machine and a method of production offering a freedom of design of a glass object considerably wider than previously. The parison may be subject to blowing whereas the lower portion may be provided with a bulge facilitating the mechanical resistance of the assembly.

1. Machine for manufacturing glass objects, comprising a blank mold (1) configured to receive glass at flow temperature, and a pressing punch (2) moveable in translation along a first axis, the blank mold (1) comprises an upwardly flared upper portion (3) formed of one-piece, and an upwardly non-flared lower portion (13) and produced in a plurality of parts, the parts of the lower portion (13) being moveable in translation with a component along axes arranged in a plane normal to the first axis, the upper portion (3) having, along any axis normal to the first axis, a minimum dimension greater than the maximum dimension of the lower portion (13) along said axis normal to the first axis so that the molded object in the lower portion (13) can pass into the upper portion (3) in translation along the first axis.

2. The machine according to claim 1, wherein the upper portion (3) constitutes a parison mold and the lower portion (13) constitutes a member mold arranged below the parison.

3. The machine according to claim 1, wherein the parts of the lower portion (13) are at least two in number.

4. The machine according to claim 1, wherein the parts of the lower portion (13) are mold sectors (15).

5. The machine according to claim 1, wherein the parts of the lower portion (13) define a lateral, preferably annular, protrusion.

6. The machine according to claim 1, wherein the parts of the lower portion (13) are moveable in translation in the plane normal to the first axis.

7. The machine according to claim 1, wherein the mold has a molding position wherein the parts of the lower portion (13) are clamped against one another defining a molding surface (14) open towards the upper portion (3) and closed laterally and downwardly, and an opening position wherein the parts of the lower portion (13) are moved apart from one another, the blank (51) then able to be demolded.

8. The machine according to claim 1, comprising an actuator (22) arranged below the lower portion (13) and acting on the parts of the lower portion (13) between a clamped position and a position moved apart from one another.

9. The machine according to claim 8, wherein between the actuator (22) and the parts of the lower portion (13) are provided inclined ramps transforming the translation along the first axis into translation along the second axis.

10. The machine according to claim 1, further comprising a blow mold (60) assembled downstream of the blank mold (1), the blow mold (60) being configured to be without contact deforming with the lower portion (13) of the blank (51) corresponding to the lower portion (13) of the blank mold (1).

11. Method for manufacturing glass objects, comprising:
providing a blank mold (1) with closed bottom, comprising an upwardly flared upper portion (3) formed of one-piece, and an upwardly non-flared lower portion (13) and produced in a plurality of parts,
pouring glass at flow temperature into the blank mold (1),
moving a pressing punch (2) moveable in translation along a first axis by pressing the glass against the blank mold (1), then removing same,
moving apart said parts of the lower portion (13) moveable in translation,
demolding the blank (51) from the upper portion (3) from the mold by a movement along the first axis.
